(19) United States
(12) Patent Application Publication
(10) Pub. No.: US 2025/0126048 A1
(43) Pub. Date: Apr. 17, 2025

(54) DATA TRANSMISSION

(71) Applicant: Tencent Technology (Shenzhen) Company Limited, Shenzhen (CN)

(72) Inventor: Yipeng ZHANG, Shenzhen (CN)

(73) Assignee: Tencent Technology (Shenzhen) Company Limited, Shenzhen (CN)

(21) Appl. No.: 19/000,618

(22) Filed: Dec. 23, 2024

Related U.S. Application Data
(63) Continuation of application No. PCT/CN2023/114153, filed on Aug. 22, 2023.

(30) Foreign Application Priority Data
Dec. 21, 2022 (CN) 202211681271.9

(51) Int. Cl. H04L 45/12; H04L 67/51

(52) U.S. Cl. CPC H04L 45/123; H04L 67/51

(57) ABSTRACT

In a method, respective cost values of data transmission by a plurality of communication networks on each communication service of a plurality of communication services is calculated. A potential target communication network with a smallest cost value for each communication service in the plurality of communication services is determined from the plurality of communication networks and based on the respective cost values. First one or more candidate communication services with one or more smallest cost values are selected from a set of communication services having a first communication network as the potential target communication network. The first communication network is a target communication network. One or more target communication services from the first one or more candidate communication services are determined based on an idle communication resource quantity of the first communication network, Service data of the target communication services is transmitted through the first communication network.

### RELATED APPLICATIONS

The present application is a continuation of International Application No. PCT/CN2023/114153, entitled “DATA TRANSMISSION METHOD AND APPARATUS, ELECTRONIC DEVICE, AND STORAGE MEDIUM” and filed on Aug. 22, 2023, which claims priority to Chinese Patent Application No. 202211681271.9, entitled “DATA TRANSMISSION METHOD AND APPARATUS, ELECTRONIC DEVICE, AND STORAGE MEDIUM” and filed on Dec. 21, 2022. The entire disclosures of the prior applications are hereby incorporated by reference.

### FIELD OF THE TECHNOLOGY

This disclosure relates to the field of computer technologies, including data transmission.

### BACKGROUND OF THE DISCLOSURE

With the development of communication technologies and the deployment of communication facilities, a position of a communication terminal is usually covered with a plurality of communication networks, and the communication terminal may select a communication network for performing data transmission from the plurality of communication networks.

In the related art, a communication network with the highest signal strength is usually selected from the plurality of communication networks, and data of the communication terminal is transmitted through the communication network with the highest signal strength. However, this manner is prone to overloading the communication network, causing the communication network to crash, thereby reducing data transmission performance.

### SUMMARY

Embodiments of this disclosure provide a data transmission method and apparatus, a device, and a medium, thereby improving data transmission performance at least to some extent.

Some aspects of the disclosure provide a method of data transmission. The method includes obtaining, communication service information and communication network information associated with a communication terminal device, the communication service information indicates a plurality of communication services to be performed for the communication terminal device, and the communication network information indicates a plurality of communication networks that are available to the communication terminal device. The method also includes calculating, based on the communication service information and the communication network information, respective cost values of data transmission by the plurality of communication networks on each communication service of the plurality of communication services. The method includes determining, from the plurality of communication networks and based on the respective cost values, a potential target communication network with a smallest cost value for each communication service in the plurality of communication services; and selecting, from a set of communication services having a first communication network as the potential target communication network, first one or more candidate communication services with one or more smallest cost values. The first communication network is a target communication network. The method also includes determining one or more target communication services from the first one or more candidate communication services based on an idle communication resource quantity of the first communication network and transmitting service data of the one or more target communication services through the first communication network.

Some aspects of the disclosure provide an apparatus for data transmission. The apparatus includes processing circuitry configured to obtain, communication service information and communication network information of a communication terminal device, the communication service information indicates a plurality of communication services to be performed for the communication terminal device, and the communication network information indicates a plurality of communication networks that are available to the communication terminal device. The processing circuitry is configured to calculate, based on the communication service information and the communication network information, respective cost values of data transmission by the plurality of communication networks on each communication service of the plurality of communication services. The processing circuitry is configured to determine, from the plurality of communication networks and based on the respective cost values, a potential target communication network with a smallest cost value for each communication service in the plurality of communication services. The processing circuitry is configured to select, from a set of communication services having a first communication network as the potential target communication network, first one or more candidate communication services with one or more smallest cost values. The first communication network is a target communication network. The processing circuitry is also configured to determine one or more target communication services from the first one or more candidate communication services based on an idle communication resource quantity of the first communication network. The processing circuitry is configured to transmit service data of the one or more target communication services through the first communication network.

Some aspects of the disclosure also provide a non-transitory computer-readable storage medium storing instructions which when executed by at least one processor cause the at least one processor to perform obtaining communication service information and communication network information associated with a communication terminal device. The communication service information indicates a plurality of communication services to be performed for the communication terminal device, and the communication network information indicates a plurality of communication networks that are available to the communication terminal device. The instructions also cause the at least one processor to perform calculating, based on the communication service information and the communication network information, respective cost values of data transmission by the plurality of communication networks on each communication service of the plurality of communication services. The instructions cause the at least one processor to perform determining, from the plurality of communication networks and based on the respective cost values, a potential target communication network with a smallest cost value for each communication service in the plurality of communication services; and selecting, from a set of communication services having a first communication network as the potential target communication network, first one or more candidate communication services with one or more smallest cost values. The first communication network is a target communication network. The instructions also cause the at least one processor to perform determining one or more target communication services from the first one or more candidate communication services based on an idle communication resource quantity of the first communication network, and transmitting service data of the one or more target communication services through the first communication network.

An embodiment of this disclosure provides a data transmission method, including:
obtaining information about a plurality of communication services and a plurality of communication networks, and calculating, based on the information, a cost value of data transmission performed by each communication service in the plurality of communication services on each communication network in the plurality of communication networks;
determining, from the plurality of communication networks based on the calculated cost value, a communication network with a smallest cost value corresponding to each communication service;
selecting, from the plurality of communication services, a communication network with a smallest cost value corresponding to the communication network as a target communication network; and
extracting a specified quantity of target communication services from the candidate communication services based on an idle communication resource quantity of the target communication network, and transmitting service data corresponding to the target communication services through the target communication network.

An embodiment of this disclosure provides a data transmission apparatus, including:
an obtaining module, configured to obtain information about a plurality of communication services and a plurality of communication networks, and calculate, based on the information, a cost value of data transmission performed by each communication service in the plurality of communication services on each communication network in the plurality of communication networks;
a search module, configured to determine, from the plurality of communication networks based on the calculated cost value, a communication network with a smallest cost value corresponding to each communication service;
a selection module, configured to select, from the plurality of communication services, a communication network with a smallest cost value corresponding to the communication network as a target communication network; and
a transmission module, configured to extract a specified quantity of target communication services from candidate communication services based on an idle communication resource quantity of the target communication network, and transmit service data corresponding to the target communication services through the target communication network.

An embodiment of this disclosure provides an electronic device, including:
one or more processors; and
a memory, configured to store one or more computer programs, the one or more computer programs, when executed by one or more processors, causing the electronic device to implement the data transmission method as described above.

An embodiment of this disclosure provides a computer-readable medium, having a computer program stored herein, the computer program, when executed by a processor of an electronic device, causing the electronic device to implement the data transmission method as described above.

An embodiment of this disclosure provides a computer program product, including computer program, the computer program, when executed by a processor, implementing the data transmission method as described above.

In the technical solutions provided in the embodiments of this disclosure, information about a plurality of communication services and a plurality of communication networks is first obtained, and based on the information, a cost value of data transmission performed by each communication service in the plurality of communication services on each communication network in the plurality of communication networks is calculated. Then, based on a calculated cost value, a communication network with a smallest cost value corresponding to each communication service is determined from the plurality of communication networks, to select, from the plurality of communication services, candidate communication services corresponding to a communication network with a smallest cost value that is a target communication network. A specified quantity of target communication services are extracted from the candidate communication services based on an idle communication resource quantity of the target communication network, and service data corresponding to the target communication services is transmitted through the target communication network. Compared with the related art, the target communication services are selected with reference to the cost value required for the communication service to respectively perform data transmission in the plurality of communication networks and the idle communication resource quantity of the target communication network, and the service data corresponding to the target communication services is transmitted through the target communication network, thereby improving an adaptation degree between the communication service and the communication network transmitting the service data of the communication service, reducing the cost value of data transmission performed by the communication network, reducing a probability of overloading and crashing of the communication network, and improving data transmission performance.

The foregoing descriptions and the following detailed descriptions are merely for illustration and explanation purposes and are not intended to limit this disclosure.

### BRIEF DESCRIPTION OF THE DRAWINGS

FIG. 1 is a schematic diagram of an implementation environment of the technical solutions according to embodiments of this disclosure.

FIG. 2 is a flowchart of a data transmission method according to an embodiment of this disclosure.

FIG. 3 is a flowchart of a data transmission method according to another embodiment of this disclosure.

FIG. 4 is a flowchart of a data transmission method according to another embodiment of this disclosure.

FIG. 5 is a flowchart of a data transmission method according to another embodiment of this disclosure.

FIG. 6 is a flowchart of a data transmission method according to another embodiment of this disclosure.

FIG. 7 is a flowchart of a data transmission method according to another embodiment of this disclosure.

FIG. 8 is a flowchart of a data transmission method according to another embodiment of this disclosure.

FIG. 9 is a flowchart of a data transmission method according to another embodiment of this disclosure.

FIG. 10 is a flowchart of a data transmission method according to another embodiment of this disclosure.

FIG. 11 is a flowchart of a data transmission method according to another embodiment of this disclosure.

FIG. 12 is a flowchart of a data transmission method according to another embodiment of this disclosure.

FIG. 13 is a flowchart of a data transmission method according to another embodiment of this disclosure.

FIG. 14 is a flowchart of determining a switching manner according to an embodiment of this disclosure.

FIG. 15 is a flowchart of determining a target communication service according to an exemplary of this disclosure.

FIG. 16 is a block diagram of a data transmission apparatus according to an of this disclosure.

FIG. 17 is a schematic structural diagram of a computer system adapted to implement an electronic device according to an embodiment of this disclosure.

### DESCRIPTION OF EMBODIMENTS

Embodiments are described in further detail below, and examples of the embodiments are shown in the accompanying drawings. When the following descriptions are made with reference to the accompanying drawings, unless otherwise indicated, same numbers in different accompanying drawings represent same or similar elements. The following implementations described in the following embodiments do not represent all implementations that are consistent with this disclosure. On the contrary, the implementations are merely examples of an apparatus and a method that are consistent with some aspects of this disclosure.

The block diagrams shown in the accompanying drawings are merely functional entities and do not necessarily correspond to physically independent entities. That is, the functional entities may be implemented in a software form, or in one or more hardware modules or integrated circuits, or in different networks and/or processor apparatuses and/or microcontroller apparatuses.

The flowcharts shown in the accompanying drawings are merely examples for descriptions, do not necessarily include all content and operations/blocks, and are not necessarily performed in the described orders. For example, some operations/blocks may further be divided, while some operations/blocks may be combined or partially combined. Therefore, an actual execution order may change according to an actual case.

“Plurality of” mentioned in this disclosure means two or more. “And/or” describes an association relationship between associated objects and represents that three relationships may exist. For example, A and/or B may represent the following three cases: Only A exists, both A and B exist, and only B exists. The character “/” generally represents an “or” relationship between the associated objects.

Descriptions of terms in this disclosure are provided as examples only and are not intended to limit the scope of the disclosure.

With the development of communication technologies and the deployment of communication facilities, a position of a communication terminal is usually covered with a plurality of communication networks, and the communication terminal may select a communication network for performing data transmission from the plurality of communication networks. In the related art, a communication network with the highest signal strength is usually selected from the plurality of communication networks, and data of the communication terminal is transmitted through the communication network with the highest signal strength. However, in this manner, the communication network is prone to overloading and crashing, thereby reducing data transmission performance. Based on this, the embodiments of this disclosure provide a data transmission method, a data transmission apparatus, an electronic device, and a computer-readable medium, which can improve data transmission performance.

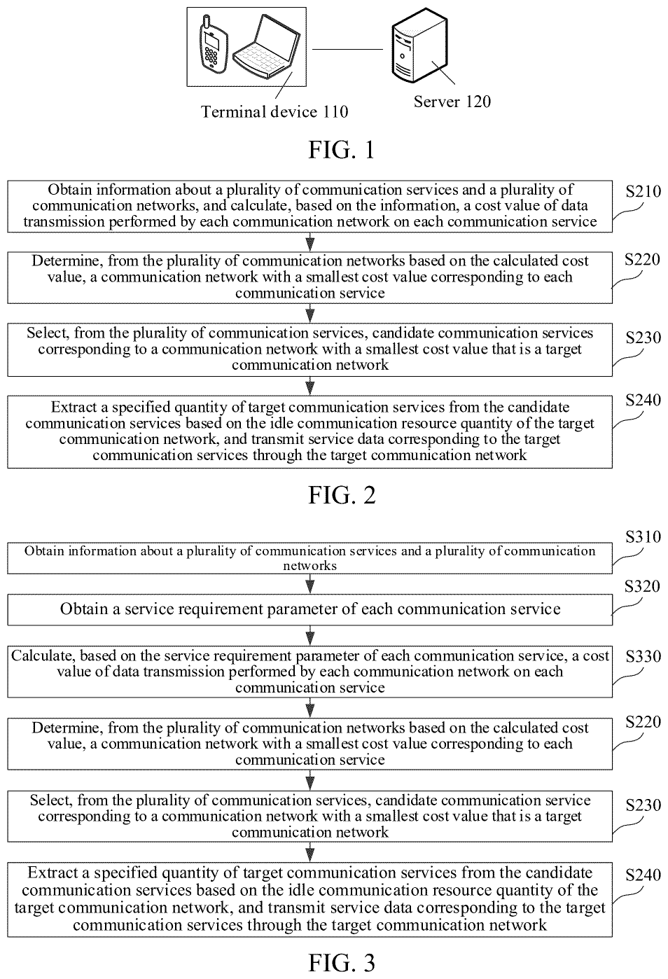

FIG. 1 is a schematic diagram of an implementation environment involved in this disclosure. The implementation environment includes a terminal device (a communication terminal) 110 and a server 120. The terminal device 110 may communicate with the server 120 by using a wired or wireless network. The terminal device 110 may upload data of the terminal device to the server 120, or may obtain data from the server 120.

The terminal device 110 may include, but is not limited to, a smartphone, a tablet computer, a notebook computer, a computer, a smart speech interaction device, a smart household appliance, an in-vehicle terminal, an aircraft, or the like.

The server 120 may be an independent physical server, or may be a server cluster or a distributed system formed by a plurality of physical servers, or may further be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform, which is not limited herein.

A quantity of terminal devices 110 and servers 120 in FIG. 1 is merely an example. According to actual needs, there may be any number of terminal devices 110 and servers 120.

In an embodiment, the data transmission method provided in the embodiments of this disclosure may be performed by the terminal device 110.

For example, the terminal device 110 may obtain information about a plurality of communication services included in the terminal device 110 and a plurality of communication networks, and calculate, based on the information, a cost value of data transmission performed by each communication service in each communication network. Then, the terminal device 110 determines, from the plurality of communication networks based on the calculated cost value, a communication network with a smallest cost value corresponding to each communication service, to select, from the plurality of communication services, candidate communication services corresponding to a communication network with the smallest cost value that is a target communication network. The terminal device 110 extracts a specified quantity of target communication services from the candidate communication services based on an idle communication resource quantity of the target communication network, and transmits service data corresponding to the target communication services through the target communication network. Therefore, the target communication services are selected with reference to the cost value required for the communication service to respectively perform data transmission in the plurality of communication networks and the idle communication resource quantity of the target communication network, and the service data corresponding to the target communication services is transmitted through the target communication network, thereby improving an adaptation degree between the communication service and the communication network transmitting the service data of the communication service, reducing the cost value of data transmission performed by the communication network, reducing a probability of overloading and crashing of the communication network, and improving data transmission performance.

In another embodiment, the server 120 may have a function similar to a function of the terminal device 110, to perform the data transmission method provided in the embodiments of this disclosure. For example, the server 120 may obtain information about a plurality of communication services included in the server 120 and a plurality of communication networks, and calculate, based on the information, a cost value of data transmission performed by each communication network on each communication service. Then, the server 120 determines, from the plurality of communication networks based on the calculated cost value, a communication network with a smallest cost value corresponding to each communication service, to select, from the plurality of communication services, candidate communication services corresponding to a communication network with a smallest cost value that is a target communication network. The server 120 extracts a specified quantity of target communication services from the candidate communication services based on an idle communication resource quantity of the target communication network, and transmits service data corresponding to the target communication services through the target communication network.

In another embodiment, the data transmission method provided in the embodiments of this disclosure may further be jointly performed by the terminal device 110 and the server 120. For example, the server 120 may first obtain information about a plurality of communication services included in the terminal device 110 and a plurality of communication networks, and calculate, based on the information, a cost value of data transmission performed by each communication network on each communication service. The server 120 determines, from the plurality of communication networks based on the calculated cost value, a communication network with a smallest cost value corresponding to each communication service, to select, from the plurality of communication services, candidate communication services corresponding to a communication network with a smallest cost value that is a target communication network. The server 120 extracts a specified quantity of target communication services from the candidate communication services based on an idle communication resource quantity of the target communication network, and then sends the target communication services and the target communication network to the terminal device 110, so that the terminal device 110 transmits service data corresponding to the target communication services through the target communication network.

The data transmission method provided in the embodiments of this disclosure may be applied to different application scenarios, for example, may be applied to a data transmission scenario of an in-vehicle terminal. For data related to a user, such as a parameter corresponding to the communication service and a parameter corresponding to the communication network, when the data transmission method in this disclosure is applied to a specific product or technology, permission or consent of the user is obtained, and extraction, use, and processing of relevant data comply with local security standards and local laws and regulations.

Various implementation details of the technical solutions of the embodiments of this disclosure are described below in detail.

FIG. 2 is a flowchart of a data transmission method according to an embodiment of this disclosure. The method may be applied to the implementation environment shown in FIG. 1, and may be performed by the terminal device 110 in the implementation environment shown in FIG. 1, or may be performed by the server 120 in the implementation environment shown in FIG. 1, or may be jointly performed by the terminal device 110 and the server 120 in the implementation environment shown in FIG. 1.

As shown in FIG. 2, the data transmission method includes at least operation S210 to operation S240, which are described in detail as follows.

Operation S210: Obtain information about a plurality of communication services and a plurality of communication networks, and calculate, based on the information, a cost value of data transmission performed by each communication network of the plurality of communication networks on each communication service of the plurality of communication services.

The communication terminal may include the plurality of communication services, and a position of the communication terminal may be covered by the plurality of communication networks. Different communication networks have different features, and costs paid for data transmission may also be different. To determine a communication network configured for transmitting service data corresponding to a communication service and reduce a data transmission cost, information about the plurality of communication services and the plurality of communication networks may be first obtained, and the cost value of data transmission performed by each communication network on each communication service is calculated based on the information.

The communication network is a network in which communication nodes are connected to implement communication between the communication nodes. Types of the communication network include, but are not limited to, a cellular communication network, the Internet of Vehicles, a wireless local area network (WLAN), and the like. The cellular communication network, also referred to as a mobile network, is a mobile communication hardware architecture, classified into an analog cellular communication network and a digital cellular communication network, and includes at least one of a global system for mobile communications (GSM) network, a code division multiple access (CDMA) network, a 3rd generation mobile communication technology (3G) network, a 4th generation mobile communication technology (4G) network, or a 5th generation mobile communication technology (5G) network. The Internet of Vehicles is a network that enables communication between a vehicle and a vehicle, a vehicle and a pedestrian, a vehicle and a service platform, a vehicle and a road side unit (RSU), and the like, for example, the Internet of Vehicles established based on a C-V2X technology. The Internet of Vehicles may be classified into a vehicle direct communication network and a non-vehicle direct communication network based on whether connection is directly performed. The vehicle direct communication network enables direct connection between communication terminals (for example, an in-vehicle terminal and a road side unit) in the Internet of Vehicles. In other words, direct communication may be performed between the in-vehicle terminal and another in-vehicle terminal, between the in-vehicle terminal and the road side unit, and the like. The vehicle direct communication network may be implemented based on a PC5 direct communication air interface of a sidelink. That is, the communication terminal may transmit data outward through the PC5 direct communication air interface of the sidelink. In an example, the vehicle direct communication network may be a network that enables the communication terminal in the Internet of Vehicles to directly transmit data without forwarding by a base station. The non-vehicle direct communication network may be a network in which the communication terminal in the Internet of vehicles needs to perform communication through forwarding by the base station. For example, the communication terminal such as the in-vehicle terminal or the road side unit needs to transmit data to the base station, and then the data is forwarded to a recipient by the base station. The base station includes, but is not limited to, a cellular network base station.

The communication service is any service that needs to transmit data to another communication terminal or receive data from another communication terminal. For example, based on different types of data that needs to be transmitted, the communication service includes an audio type service (for example, a music playing service and an audio call service) in which audio needs to be transmitted, a video type service (for example, a video playing service and a video call service) in which a video needs to be transmitted, and a text type service (for example, an instant messaging service and a news service) in which a text message type needs to be transmitted. Different application scenarios correspond to different communication services. For example, in a field of Internet of Vehicles, based on different communication objects, the communication service includes at least one of a vehicle to vehicle (V2V) communication service, a vehicle to infrastructure (V2I) communication service, a vehicle to pedestrian (V2P) communication service, or the like.

The vehicle to vehicle communication service is a service that requires data transmission between in-vehicle terminals, to implement a corresponding function based on transmitted data. For example, in a vehicle collision avoidance service, the in-vehicle terminal needs to communicate with another in-vehicle terminal to determine information such as a vehicle distance, so that corresponding control is performed based on the information such as the vehicle distance to avoid a collision between vehicles. The vehicle to infrastructure communication service is a service that requires data transmission between an in-vehicle terminal and an infrastructure, to implement a corresponding function based on transmitted data. For example, in a traffic light prompt service, the in-vehicle terminal needs to communicate with a traffic light device to determine whether a traffic light exists in front of the vehicle, thereby prompting a driver of the in-vehicle terminal to pay attention to the traffic light in front. The vehicle to pedestrian communication service is a service that requires data transmission between an in-vehicle terminal and a terminal held by a pedestrian, to implement a corresponding function based on transmitted data. For example, in a pedestrian reminder service, the in-vehicle terminal needs to communicate with a terminal held by a pedestrian to determine information such as a distance between the vehicle and the pedestrian, so that a driver is prompted to pay attention to avoiding the pedestrian during driving based on the information such as the distance between the vehicle and the pedestrian.

A cost value of data transmission performed by a communication service in a communication network or a cost value of data transmission performed by a communication network on a communication service is a cost paid for the communication network to transmit service data of the communication service.

A specific manner of calculating the cost value of data transmission performed by each communication network on each communication service may be flexibly set according to actual needs. A preset cost value information set may be searched for the cost value of data transmission performed by each communication network on each communication service. The cost value information set includes mapping relationships between the plurality of communication services, the plurality of communication networks, and a plurality of cost values.

Operation S220: Determine, from the plurality of communication networks based on the calculated cost value, a communication network with a smallest cost value corresponding to each communication service.

After the cost value of data transmission performed by each communication network on each communication service is calculated, to reduce a load on the communication network and reduce the cost value of data transmission, for each communication service, the plurality of communication networks may be searched for the communication network with the smallest cost value corresponding to the communication network.

Operation S230: Select, from the plurality of communication services, candidate communication services corresponding to a communication network with a smallest cost value that is a target communication network.

After the communication network with the smallest cost value corresponding to each communication service is determined, to determine whether to transmit the service data corresponding to the communication service by using the target communication network, the candidate communication services corresponding to the communication network with the smallest cost value that is the target communication network may be selected from the plurality of communication services. In other words, the communication network with the smallest cost value corresponding to the candidate communication services is the target communication network. For example, in an example, it is assumed that a communication service Y1, a communication service Y2, and a communication service Y3 are included, and a communication network N1, a communication network N2, and a communication network N3 are included, where the target communication network is N2. If the cost values of data transmission performed by the communication network N1, the communication network N2, and the communication network N3 on the communication service Y1 are respectively 4, 9, and 15, the communication network with the smallest cost value corresponding to the communication service Y1 is N1. If the cost values of data transmission performed by the communication network N1, the communication network N2, and the communication network N3 on the communication service Y2 are respectively 18, 8, and 26, the communication network with the smallest cost value corresponding to the communication service Y2 is N2. If the cost values of data transmission performed by the communication network N1, the communication network N2, and the communication network N3 on the communication service Y3 are respectively 17, 6, and 23, the communication network with the smallest cost value corresponding to the communication service Y3 is N2. Therefore, the candidate communication services are Y2 and Y3.

The target communication network is a communication network in the plurality of communication networks, and a specific type of the target communication network may be flexibly set according to actual needs. The target communication network may be a preset specified communication network, or may be at least one of a communication network with the most idle communication resources, a communication network with the best communication quality, or the like. In an example, if the data transmission method in the embodiments of this disclosure is applied to the in-vehicle terminal, the target communication network may be the vehicle direct communication network or the cellular communication network.

Operation S240: Extract a specified quantity of target communication services from the candidate communication services based on an idle communication resource quantity of the target communication network, and transmit service data corresponding to the target communication services through the target communication network.

After the candidate communication services are determined, to avoid an excessive load on the target communication network, the idle communication resource quantity of the target communication network may be obtained, and the specified quantity of communication services, namely, the target communication services, are extracted from the candidate communication services based on the idle communication resource quantity of the target communication network. Then, the service data corresponding to the target communication services is transmitted through the target communication network. A specific value of the specified quantity may be a preset fixed value, or may be positively correlated with the idle communication resource quantity of the target communication network. For example, a larger idle communication resource quantity of the target communication network indicates a larger specified quantity.

The idle communication resource quantity of the target communication network is configured for describing a quantity of unoccupied communication resources in the target communication network. The communication resource includes, but is not limited to, a bandwidth resource.

A specific manner of extracting the specified quantity of target communication services from the candidate communication services based on the idle communication resource quantity of the target communication network may be flexibly set according to actual needs. In an example, the specified quantity may be determined based on the idle communication resource quantity of the target communication network, and the specified quantity of communication services are extracted from the candidate communication services as the target communication services. The specified quantity is positively correlated with the idle communication resource quantity of the target communication network. Alternatively, in another example, if the idle communication resource quantity of the target communication network is greater than a set threshold, the specified quantity of communication services are extracted from the candidate communication services in descending order of communication resource demand amounts of the communication services as the target communication services. If the idle communication resource quantity of the target communication network is less than the set threshold, the specified quantity of communication services are extracted from the candidate communication services in ascending order of communication resource demand amounts of the communication services as the target communication services.

In the embodiment shown in FIG. 2, information about the plurality of communication services and the plurality of communication networks is first obtained, and based on the information, the cost value of data transmission performed by each communication network on each communication service is calculated. Then, based on the calculated cost value, a communication network with a smallest cost value corresponding to each communication service is determined from the plurality of communication networks, to select, from the plurality of communication services, candidate communication services corresponding to a communication network with a smallest cost value that is a target communication network. The specified quantity of target communication services are extracted from the candidate communication services based on the idle communication resource quantity of the target communication network, and service data corresponding to the target communication services is transmitted through the target communication network. Compared with the related art, the target communication services are selected based on the cost value of performing data transmission respectively by the plurality of communication networks on the communication service and the idle communication resource quantity of the target communication network, and the service data corresponding to the target communication services is transmitted through the target communication network, thereby improving an adaptation degree between the communication service and the communication network transmitting the service data of the communication service, reducing the cost value of data transmission performed by the communication network, reducing a probability of overloading and crashing of the communication network, and improving the data transmission performance.

In an embodiment, FIG. 3 is a flowchart of a data transmission method according to another embodiment of this disclosure. The method may be applied to the implementation environment shown in FIG. 1, and may be performed by the terminal device 110 in the implementation environment shown in FIG. 1, or may be performed by the server 120 in the implementation environment shown in FIG. 1, or may be performed by both the terminal device 110 and the server 120 in the implementation environment shown in FIG. 1.

As shown in FIG. 3, the data transmission method includes operation S310 to operation S330 and operation S220 to operation S240. Detailed descriptions of operation S310 to operation S330 are as follows.

Operation S310: Obtain information about a plurality of communication services and a plurality of communication networks.

To determine a communication network transmitting service data corresponding to a communication service, information about the plurality of communication services included in the communication network and the plurality of communication networks may be first obtained.

Operation S320: Obtain a service requirement parameter of each communication service.

To ensure a service requirement of the communication service, a service requirement parameter of the communication service may be obtained.

The service requirement parameter of the communication service is configured for describing the service requirement corresponding to the communication service, including, but not limited to, at least one of data transmission requirement parameters such as a transmission delay requirement parameter, a transmission reliability requirement parameter, or a bandwidth requirement parameter. For example, in an example, the service requirement parameter of the communication service may include at least one of a transmission delay of less than 50 milliseconds, transmission reliability of greater than 90%, or a bandwidth of greater than 20 kbps.

Operation S330: Calculate, based on the service requirement parameter of each communication service, a cost value of data transmission performed by each communication network on each communication service.

The service requirement parameters corresponding to the communication services are different, and the costs to be paid for the communication networks to ensure the service requirements of the communication networks are also different. For example, for a communication service with a higher bandwidth requirement, a cost paid for the communication network to meet the bandwidth requirement is higher, and for a communication service with a lower bandwidth requirement, a cost paid for the communication network to meet the bandwidth requirement is lower. For a communication service with a higher transmission delay requirement (for example, a millisecond level), a cost paid for the communication network to meet the transmission delay requirement is higher, and for a communication service with a lower transmission delay requirement (for example, a second level), a cost paid for the communication network to meet the transmission delay requirement is lower. Therefore, after a service requirement parameter of a communication service is obtained, a cost value of data transmission performed by each communication network on the communication service may be calculated based on the service requirement parameter of the communication service.

The foregoing operation S310 to operation S330 shown in FIG. 3 may be included in operation S210 in FIG. 2, and are further descriptions of operation S210. For specific implementation details of operation S220 to operation S240 shown in FIG. 3, reference may be made to operation S220 to operation S240 shown in FIG. 2. Details are not described herein again.

In the embodiment shown in FIG. 3, the cost value of data transmission performed by each communication network on each communication service is calculated based on the service requirement parameter of each communication service, which not only improves accuracy of calculation of the cost value, but also ensures that during subsequent actual data transmission, the target communication network can meet the service requirement of the communication service, and ensures data transmission performance and service quality.

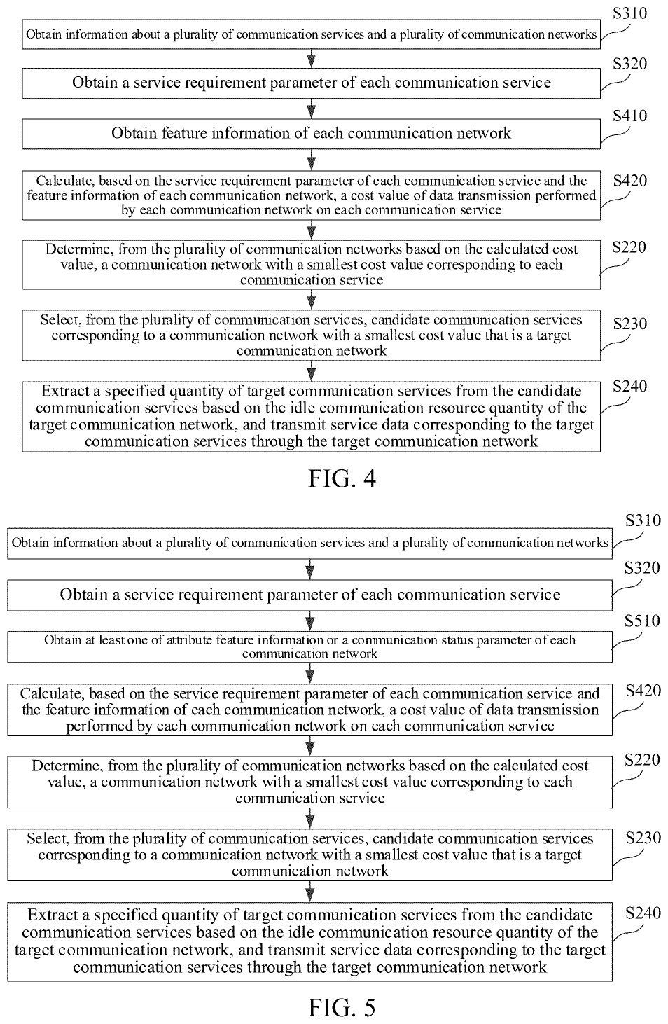

In an embodiment, FIG. 4 is a flowchart of a data transmission method according to another embodiment of this disclosure. The method may be applied to the implementation environment shown in FIG. 1, and may be performed by the terminal device 110 in the implementation environment shown in FIG. 1, or may be performed by the server 120 in the implementation environment shown in FIG. 1, or may be performed by both the terminal device 110 and the server 120 in the implementation environment shown in FIG. 1.

As shown in FIG. 4, the data transmission method includes operation S310 and operation S320, operation S410 and operation S420, and operation S220 to operation S240. Detailed descriptions of operation S410 and operation S420 are as follows.

Operation S410: Obtain feature information of each communication network.

Different communication networks have different features, so that costs required to ensure communication service requirements are also different. For example, for the cellular communication network and the vehicle direct communication network, the cellular communication network has more bandwidth resources, so that a cost paid to ensure the bandwidth requirement of the communication service is lower; and the vehicle direct communication network has fewer bandwidth resources, so that the cost paid to ensure the bandwidth requirement of the communication service is higher. For another example, the data transmission delay of the cellular communication network is longer, so that a cost paid to ensure the data transmission delay requirement of the communication service is higher; and the data transmission delay of the vehicle direct communication network is shorter, so that the cost paid to ensure the data transmission delay requirement of the communication service is lower. For another example, if the idle communication resource quantity of the communication network is smaller, the cost paid to ensure the communication resource requirement of the communication service is higher; and if a signal-to-noise ratio of the communication network is lower, and a packet loss rate is higher, a cost paid to ensure the transmission reliability requirement of the communication service is higher.

Therefore, to improve accuracy of calculation of the cost value, the feature information of each communication network may be first obtained.

The feature information of the communication network is configured for describing a feature of the communication network, including, but not limited to, at least one of attribute feature information or a communication status parameter of the communication network. The attribute feature information of the communication network is configured for describing an attribute feature of the communication network, including, but not limited to, a bandwidth resource, a data transmission delay, a coverage, or the like. For example, the cellular communication network has attributes such as a large number of bandwidth resources, a long data transmission delay, and a wide coverage. The vehicle direct communication network has attributes such as a small number of bandwidth resources, a short data transmission delay, and a small coverage. The communication status parameter of the communication network is configured for describing a current communication status of the communication network, and includes, but not limited to, at least one of an idle communication resource quantity, reference signal receiving power (RSRP), a signal to interference plus noise ratio (SINR), a received signal strength indication, reference signal received quality (RSRQ), or the like. Types of obtained communication status parameters may be different for different communication networks.

Operation S420: Calculate, based on the service requirement parameter of each communication service and the feature information of each communication network, a cost value of data transmission performed by each communication network on each communication service.

After the service requirement parameter of each communication service and the feature information of each communication network are obtained, the cost value of data transmission performed by each communication network on each communication service may be calculated based on the service requirement parameter of each communication service and the feature information of each communication network.

A matching degree between the service requirement parameter of each communication service and the feature information of each communication network may be calculated, and the cost value of data transmission performed by each communication network on each communication service is determined based on the matching degree. The matching degree is negatively correlated with the cost value. A higher matching degree indicates a lower cost value.

Operation S410 and operation S420 shown in FIG. 4 may be included in operation S330 in FIG. 3, and are further descriptions of operation S330. For specific implementation details of operation S220 to operation S240 shown in FIG. 4, reference may be made to operation S220 to operation S240 shown in FIG. 2. For specific implementation details of operation S310 and operation S320 shown in FIG. 4, reference may be made to operation S310 and operation S320 shown in FIG. 3. Details are not described herein again.

In the embodiment shown in FIG. 4, the cost value of data transmission performed by each communication network on each communication service is calculated based on the service requirement parameter of each communication service and the feature information of each communication network, so that accuracy of calculation of the cost value can be improved.

In an embodiment, FIG. 5 is a flowchart of a data transmission method according to another embodiment of this disclosure. The method may be applied to the implementation environment shown in FIG. 1, and may be performed by the terminal device 110 in the implementation environment shown in FIG. 1, or may be performed by the server 120 in the implementation environment shown in FIG. 1, or may be performed by both the terminal device 110 and the server 120 in the implementation environment shown in FIG. 1.

As shown in FIG. 5, the data transmission method includes operation S310 and operation S320, operation S510, operation S420, and operation S220 to operation S240. Detailed descriptions of operation S510 is as follows.

Operation S510: Obtain at least one of attribute feature information or a communication status parameter of each communication network.

To improve accuracy of the cost value, at least one of the attribute feature information or the communication status parameter of each communication network may be obtained, so that the cost value of data transmission performed by each communication network on each communication service may be calculated based on the communication status parameter of each communication network and the service requirement parameter of each communication service. Alternatively, the cost value of data transmission performed by each communication network on each communication service is calculated based on the attribute feature information of each communication network and the service requirement parameter of each communication service. Alternatively, the cost value of data transmission performed by each communication network on each communication service is calculated based on the attribute feature information of each communication network, the communication status parameter of each communication network, and the service requirement parameter of each communication service.

Operation S510 shown in FIG. 5 may be included in operation S410 in FIG. 4, or be a replacement thereof. For specific implementation details of operation S220 to operation S240 shown in FIG. 5, reference may be made to operation S220 to operation S240 shown in FIG. 2. For specific implementation details of operation S310 and operation S320 shown in FIG. 5, reference may be made to operation S310 and operation S320 shown in FIG. 3. For specific implementation details of operation S420 shown in FIG. 5, reference may be made to operation S420 shown in FIG. 4. Details are not described herein again.

In the embodiment shown in FIG. 5, at least one of the attribute feature information or the communication status parameter of each communication network is obtained, and the cost value is calculated based on the obtained data, so that accuracy of the cost value can be improved.

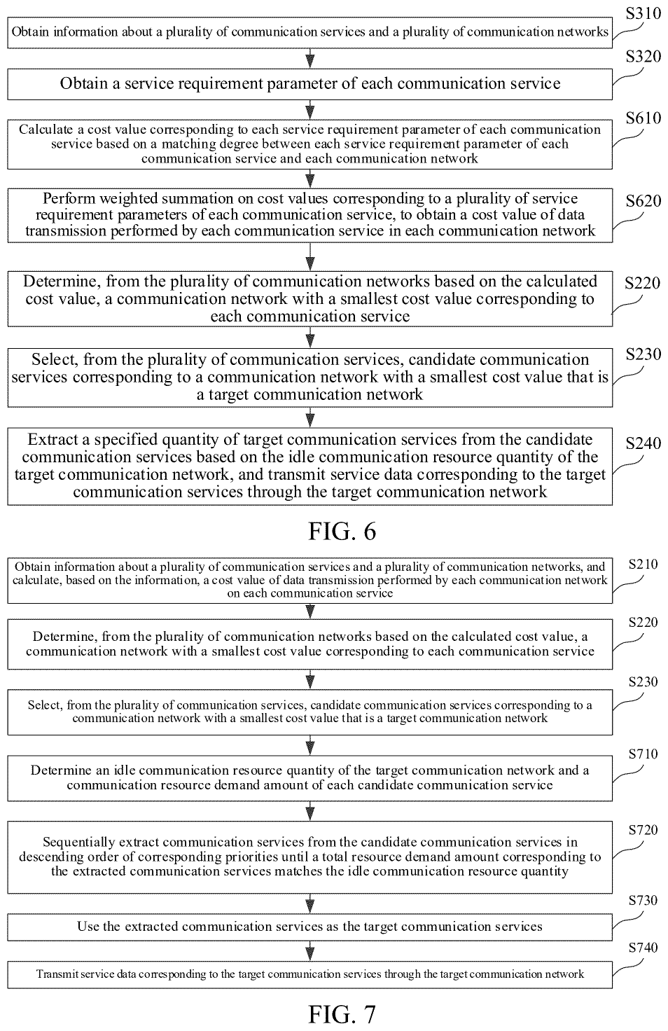

In an embodiment, FIG. 6 is a flowchart of a data transmission method according to another embodiment of this disclosure. The method may be applied to the implementation environment shown in FIG. 1, and may be performed by the terminal device 110 in the implementation environment shown in FIG. 1, or may be performed by the server 120 in the implementation environment shown in FIG. 1, or may be performed by both the terminal device 110 and the server 120 in the implementation environment shown in FIG. 1.

As shown in FIG. 6, under a condition that the service requirement parameter of each communication service includes a plurality of service requirement parameters of each communication service, the data transmission method includes operation S310 and operation S320, operation S610 and operation S620, and operation S220 to operation S240. Detailed descriptions of operation S610 to operation S620 are as follows.

Operation S610: Calculate a cost value corresponding to each service requirement parameter of each communication service based on a matching degree between each service requirement parameter of each communication service and each communication network.

Under a condition that each communication service includes a plurality of service requirement parameters, due to different features of different communication networks, cost values paid to meet different types of service requirement parameters are different. Therefore, the matching degree between each service requirement parameter of each communication service and each communication network may be first calculated, and the cost value of each service requirement parameter of each communication service for each communication network is determined based on the calculated matching degree. That is, the calculated cost value is a cost value paid for each communication network to meet each service requirement parameter of each communication service. For example, in an example, a communication service 1 includes three service requirement parameters, and the communication network includes a communication network 1 and a communication network 2. In this case, cost values (also referred to as component cost values) of a first service requirement parameter, a second service requirement parameter, and a third service requirement parameter of the communication service 1 in the communication network 1 are respectively calculated, and cost values (also referred to as component cost values) of the first service requirement parameter, the second service requirement parameter, and the third service requirement parameter of the communication service 1 in the communication network 2 are respectively calculated.

The matching degree between each service requirement parameter of each communication service and each communication network may be calculated based on each service requirement parameter of each communication service and the feature information of each communication network.

Operation S620: Perform weighted summation on cost values corresponding to the plurality of service requirement parameters of each communication service, to obtain the cost value of data transmission performed by each communication network on each communication service.

To improve the accuracy of calculation of the cost value, corresponding weight values are set for the plurality of service requirement parameters of the communication service. Weighted summation may be performed on the cost values of each communication network respectively corresponding to the plurality of service requirement parameters of the communication service based on corresponding weight values, to obtain the cost value of data transmission performed by the communication service on each communication network.

A manner of setting the weight value corresponding to the service requirement parameter of the communication service may be flexibly set according to actual needs, for example, may be set based on the service requirement. For a communication service with a high delay requirement, a weight value corresponding to the delay requirement parameter may be relatively high. For example, a blind spot vehicle reminder service needs to obtain surrounding vehicle information with as short a delay as possible, to prompt a driver to pay attention to the vehicle in a case that a blind spot exists. Therefore, the weight value corresponding to the delay requirement parameter may be relatively high. For example, a sensor parameter sharing service needs to transmit more data, a requirement for bandwidth resources is high, and a requirement for transmission reliability is relatively low. Therefore, the weight value corresponding to the bandwidth requirement parameter may be relatively high, and the weight value corresponding to the transmission reliability requirement parameter may be relatively low. To properly set the weight value, the weight value corresponding to each service requirement parameter of each communication service may be a value greater than or equal to 0 and less than or equal to 1. A sum of weight values corresponding to a plurality of service requirement parameters of the same communication service is 1.

For example, the cost value of data transmission performed by each communication network on each communication service may be calculated according to the following Formula (1):

$${C}_{n , a} = \sum {w}_{a , i} {u}_{n , a , i} \qquad ( Formula 1 )$$

n represents a communication network type, a represents a communication service type, i represents a service requirement parameter type, u_{n,a,i} represents a cost value that the communication network n needs to pay to meet a service requirement parameter i of a communication service a, that is, a cost value of the service requirement parameter i of the communication service a in the communication network n, w_{a,i} represents a weight value corresponding to the service requirement parameter i of the communication service a, and C_{n,a} represents a cost value of data transmission performed by the communication network n on the communication service a.

For example, in an example, it is assumed that a communication service includes three service requirement parameters, and a communication network includes two communication networks, according to the foregoing Formula (1), a formula for calculating a cost value of data transmission performed by the first communication network on the communication service (that is, a cost value needs to be paid for the first communication network to meet the service requirement parameter for the communication service a=1) is as follows:

$${C}_{n = 1 , a} = {w}_{a , i = 1} * {u}_{n = 1 , a , i = 1} + {w}_{a , i = 2} * {u}_{n = 1 , a , i = 2} + {w}_{a , i = 3} * {u}_{n = 1 , a , i = 3}$$

where C_{n=1,a} is a cost value of data transmission performed by the first communication network on the communication service a, w_{a,i=1}, w_{a,i=2}, w_{a,i=3} are weight values respectively corresponding to a first service requirement parameter, a second service requirement parameter, and a third service requirement parameter of the communication service, and u_{n=1,a,i=1}, u_{n=1,a,i=2}, u_{n=1,a,i=3} are respectively cost values of the first service requirement parameter, the second service requirement parameter, and the third service requirement parameter of the communication service for the first the communication network.

A formula for calculating a cost value of data transmission performed by the second communication network on the communication service (that is, a cost value that the second communication network needs to be paid to meet the service requirement parameter for the communication service a=1) is as follows:

$${C}_{n = 2 , a} = {w}_{a , i = 1} * {u}_{n = 2 , a , i = 1} + {w}_{a , i = 2} * {u}_{n = 2 , a , i = 2} + {w}_{a , i = 3} * {u}_{n = 2 , a , i = 3}$$

where C_{n=2,a} is a cost value of data transmission performed by the second communication network on the communication service, and u_{n=2,a,i=1}, u_{n=2,a,i=2}, u_{n=2,a,i=3} are respectively cost values of the first service requirement parameter, the second service requirement parameter, and the third service requirement parameter of the communication service for the second communication network.

Operation S610 to operation S620 shown in FIG. 6 may be included in operation S330 in FIG. 3. For specific implementation details of operation S220 to operation S240 shown in FIG. 6, reference may be made to operation S220 to operation S240 shown in FIG. 2. For specific implementation details of operation S310 and operation S320 shown in FIG. 6, reference may be made to operation S310 and operation S320 shown in FIG. 3. Details are not described herein again.

In the embodiment shown in FIG. 6, the cost value corresponding to each service requirement parameter of each communication service is calculated based on the matching degree between each service requirement parameter of each communication service and each communication network, weight values respectively corresponding to the plurality of service requirement parameters of each communication service are obtained, and weighted summation is performed on the cost values corresponding to the plurality of service requirement parameters of each communication service based on obtained weight values, to obtain the cost value of data transmission performed by each communication service on each communication network, so that accuracy of calculation of the cost value can be improved.

In an embodiment, FIG. 7 is a flowchart of a data transmission method according to another embodiment of this disclosure. The method may be applied to the implementation environment shown in FIG. 1, and may be performed by the terminal device 110 in the implementation environment shown in FIG. 1, or may be performed by the server 120 in the implementation environment shown in FIG. 1, or may be performed by both the terminal device 110 and the server 120 in the implementation environment shown in FIG. 1.

As shown in FIG. 7, the data transmission method includes operation S210 to operation S230 and operation S710 to operation S740. Detailed descriptions of operation S710 to operation S740 are as follows.

Operation S710: Determine an idle communication resource quantity of a target communication network and a communication resource demand amount of each candidate communication service.

To ensure data transmission performance of the target communication services and avoid a situation that the target communication network overloading and crashing, the idle communication resource quantity of the target communication network and the communication resource demand amount of each candidate communication service may be determined.

the communication resource demand amount of the candidate communication service is configured for describing a quantity of communication resources that the candidate communication service needs to occupy during data transmission.

Operation S720: Sequentially extract communication services from the candidate communication services in descending order of corresponding priorities until a total resource demand amount corresponding to extracted communication services matches the idle communication resource quantity.

In the embodiment shown in FIG. 7, different priorities may be set for different communication services. Then, the communication services are extracted from all candidate communication services in descending order based on the priorities corresponding to all the candidate communication services until the total communication resource demand amount corresponding to the extracted communication services matches the idle communication resource quantity. The total communication resource demand amount corresponding to the extracted communication service matching the idle communication resource quantity includes, for example: a sum of the total communication resource demand amount corresponding to the extracted communication service and a communication resource demand amount of a next communication service is greater than a communication resource quantity threshold. The communication resource quantity threshold may be a product of the idle communication resource quantity and a set ratio. The set ratio may be flexibly set according to actual needs, for example, may be set to 100%. Alternatively, to avoid excessive load on the target communication network, the set ratio may be set to 90%, 80%, or the like. In other words, the total communication resource demand amount corresponding to the extracted communication services cannot exceed the communication resource quantity threshold. For example, it is assumed that all candidate communication services are, in descending order of priorities, a communication service 1, a communication service 2, a communication service 3, and a communication service 4, a total communication resource demand amount of the communication service 1 to the communication service 3 is less than the communication resource quantity threshold, and a total communication resource demand amount of the communication service 1 to the communication service 4 is greater than the communication resource quantity threshold, the communication service 1 to the communication service 3 are extracted.

A specific manner of setting the priority of the communication service may be flexibly set according to actual needs. For example, it may be set based on importance of the communication service. The importance is positively correlated with the priority, that is, a higher importance indicates a higher priority. Alternatively, it may be set based on the communication resource demand amount of the communication service.

In an implementation, it is considered that the target communication network also needs to transmit service data of another communication terminal. Therefore, to avoid an overload situation of the target communication network, in operation S710, the idle communication resource quantity allocated to the communication terminal may be determined from the idle communication resource quantity of the target communication network. In addition, in operation S720, communication services are extracted from the candidate communication services in descending order of corresponding priorities until a total resource demand amount corresponding to extracted communication services matches the idle communication resource quantity allocated to the communication terminal. A specific manner of determining the idle communication resource quantity allocated to the communication terminal may be flexibly set according to actual needs. For example, if the target communication network is the vehicle direct communication network based on the C-V2X technology, a communication resource allocation manner includes a Mode3 mode and a Mode4 mode. If currently in the Mode3 mode, the communication terminal receives the idle communication resource quantity allocated to the communication terminal by the base station. If currently in the Mode4 mode, the idle communication resource quantity of the communication terminal is applied from an idle communication resource pool of the target communication network.

Operation S730: Use the extracted communication service as the target communication service.

After the communication service is extracted, the extracted communication service may be used as the target communication service.

Operation S740: Transmit service data corresponding to the target communication services through the target communication network.

Operation S710 to operation S740 shown in FIG. 7 may be included in operation S240 in the foregoing flowcharts of FIG. 2 to FIG. 6. For specific implementation details of operation S210 to operation S230 shown in FIG. 7, reference may be made to operation S210 to operation S230 shown in FIG. 2. Details are not described herein again.

In the embodiment shown in FIG. 7, communication services are sequentially extracted from the candidate communication services in descending order of corresponding priorities until the total resource demand amount corresponding to the extracted communication services matches the idle communication resource quantity, and the extracted communication service is used as the target communication service, so that a target communication service with a higher priority can be switched to the target communication network and data transmission performance of the target communication service with the higher priority can be ensured. In addition, the target communication services are extracted based on the idle communication resource quantity of the target communication network and the communication resource demand amount of each candidate communication service, so that a load pressure of the target communication network may be reduced.

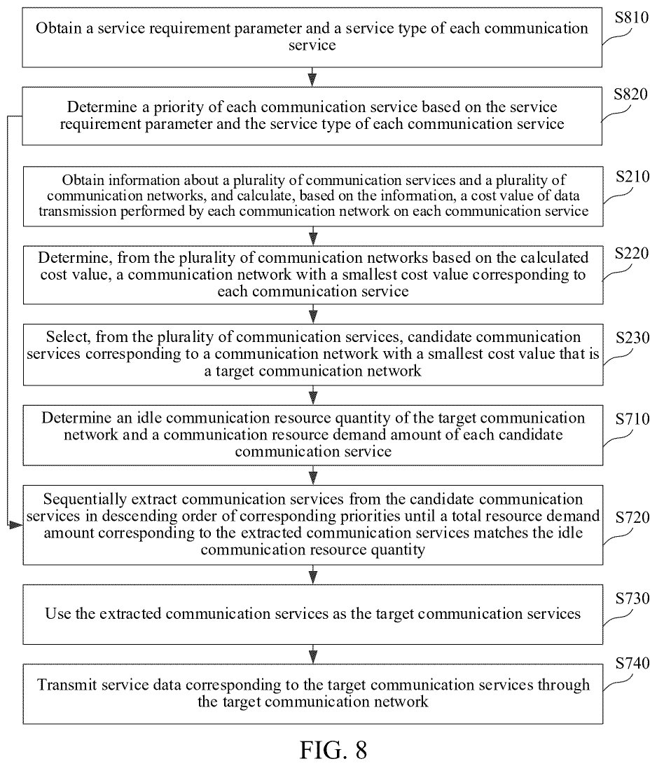

In an embodiment, FIG. 8 is a flowchart of a data transmission method according to another embodiment of this disclosure. The method may be applied to the implementation environment shown in FIG. 1, and may be performed by the terminal device 110 in the implementation environment shown in FIG. 1, or may be performed by the server 120 in the implementation environment shown in FIG. 1, or may be performed by both the terminal device 110 and the server 120 in the implementation environment shown in FIG. 1.

As shown in FIG. 8, the data transmission method includes operation S810 to operation S820, operation S210 to operation S230, and operation S710 to operation S740. Detailed descriptions of operation S810 to operation S820 are as follows.

Operation S810: Obtain a service requirement parameter and a service type of each communication service.

To accurately determine the priority of the communication service, the service requirement parameter and the service type of each communication service may be obtained.

Operation S820: Determine a priority of each communication service based on the service requirement parameter and the service type of each communication service.

After the service requirement parameter and the service type of each communication service are obtained, the priority of each communication service may be determined based on the service requirement parameter and the service type of each communication service.

For specific implementation details of operation S210 to operation S230 shown in FIG. 8, reference may be made to operation S210 to operation S230 shown in FIG. 2. For specific implementation details of operation S710 and operation S740 shown in FIG. 8, reference may be made to operation S710 to operation S740 shown in FIG. 7. Details are not described herein again.

In the embodiment shown in FIG. 8, a service requirement parameter and a service type of each communication service are obtained, and a priority of each communication service is determined based on the service requirement parameter and the service type of each communication service, so that accuracy of the priority may be improved.

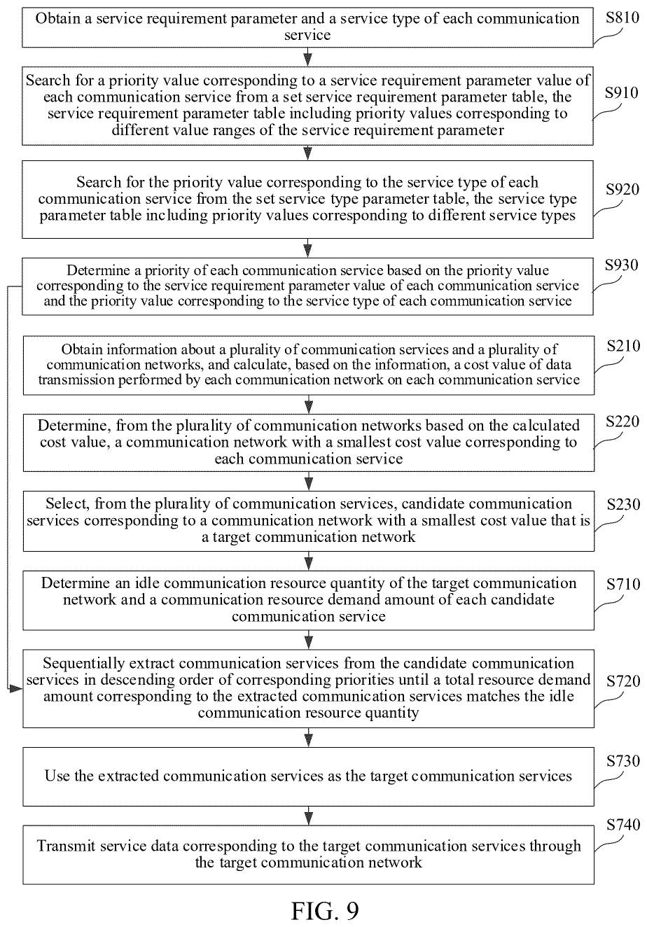

In an embodiment, FIG. 9 is a flowchart of a data transmission method according to another embodiment of this disclosure. The method may be applied to the implementation environment shown in FIG. 1, and may be performed by the terminal device 110 in the implementation environment shown in FIG. 1, or may be performed by the server 120 in the implementation environment shown in FIG. 1, or may be performed by both the terminal device 110 and the server 120 in the implementation environment shown in FIG. 1.

As shown in FIG. 9, the data transmission method includes operation S810, operation S910 to operation S930, operation S210 to operation S230, and operation S710 to operation S740. Detailed descriptions of operation S910 to operation S930 are as follows.

Operation S910: Search for a priority value corresponding to a service requirement parameter value of each communication service from a set service requirement parameter table, the service requirement parameter table including priority values corresponding to different value ranges of the service requirement parameter.

The service requirement parameter table includes a mapping relationship between the service requirement parameter type, the service requirement parameter range, and the priority value. The priority value corresponding to the service requirement parameter range to which the service requirement parameter value of each communication service belongs may be found from the service requirement parameter table. Specific forms of the service requirement parameter range and the priority value corresponding to the service requirement parameter range may be flexibly set according to actual needs. In an example, it is assumed that the service requirement parameter type in the service requirement parameter table is the transmission reliability, where a priority value corresponding to the transmission reliability of 0% to 80% is 10, a priority value corresponding to the transmission reliability of 80% to 90% is 20, and a priority value corresponding to the transmission reliability of 90% to 100% is 30. If a transmission reliability requirement parameter of a communication service is 90%, a priority value corresponding to the communication service is 30.

Operation S920: Search for a priority value corresponding to the service type of each communication service from a set service type parameter table, the service type parameter table including priority values corresponding to different service types.

The service type parameter table includes a mapping relationship between the communication service type and the priority value. The priority value corresponding to the service type of each communication service may be found from the service type parameter table. The mapping relationship between the communication service type and the priority value in the service type parameter table may be flexibly set according to actual needs.

Operation S930: Determine the priority of each communication service based on the priority value corresponding to the service requirement parameter value of each communication service and the priority value corresponding to the service type of each communication service.

A specific manner of determining the priority of each communication service may be flexibly set according to actual needs based on the priority value corresponding to the service requirement parameter value of each communication service and the priority value corresponding to the service type of each communication service. An addition operation or a multiplication operation may be performed on the priority value corresponding to the service requirement parameter value of each communication service and the priority value corresponding to the service type of each communication service, to obtain a value representing the priority of each communication service, where a larger value indicates a higher priority.

In an example, the priority of each communication service may be determined by using the following Formula (2):

$${P}_{a} = {D}_{a} \cdot {T}_{a} , \qquad ( Formula 2 )$$

Pₐ is a priority value of a communication service, Dₐ is a priority value corresponding to a service requirement parameter of the communication service, and Tₐ is a priority value corresponding to a type of the communication service.

Operation S910 to operation S930 shown in FIG. 9 may be included in operation S820 in FIG. 8. For specific implementation details of operation S210 to operation S230 shown in FIG. 9, reference may be made to operation S210 to operation S230 shown in FIG. 2. For specific implementation details of operation S710 to operation S740 shown in FIG. 9, reference may be made to operation S710 to operation S740 shown in FIG. 7. For specific implementation details of operation S810 shown in FIG. 9, reference may be made to operation S810 shown in FIG. 8. Details are not described herein again.

In the embodiment shown in FIG. 9, the priority value corresponding to the service requirement parameter value of each communication service is searched from the set service requirement parameter table, the service requirement parameter table including priority values corresponding to different value ranges of the service requirement parameter. The priority value corresponding to the service type of each communication service is searched from the set service type parameter table, the service type parameter table including priority values corresponding to different service types. Then, the priority of each communication service is determined based on the priority value corresponding to the service requirement parameter value of each communication service and the priority value corresponding to the service type of each communication service. This not only improves accuracy of determining the priority, but also reduces difficulty of determining the priority, and improves efficiency of determining the priority.

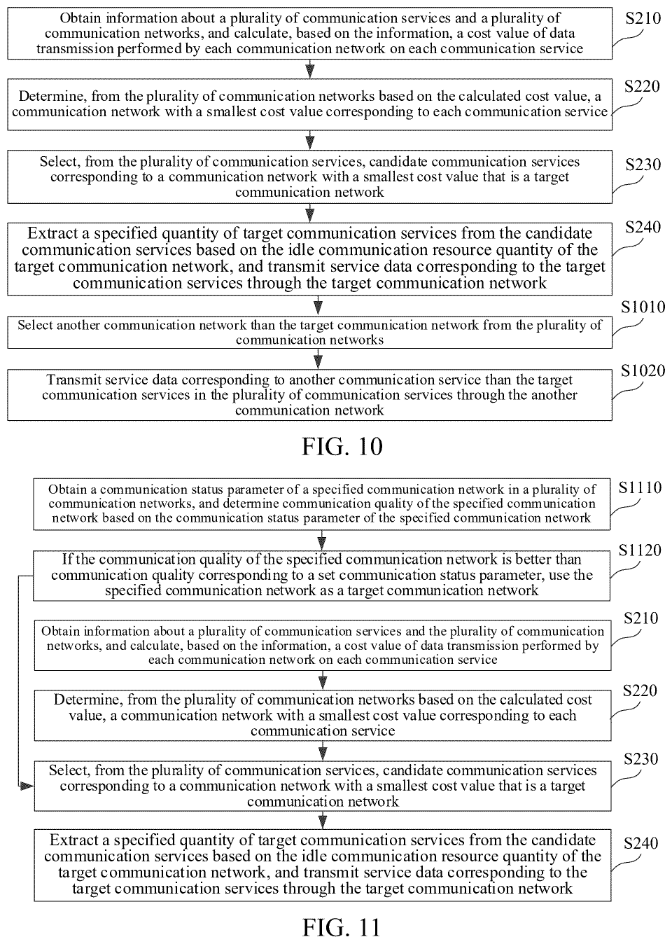

In an embodiment, FIG. 10 is a flowchart of a data transmission method according to another embodiment of this disclosure. The method may be applied to the implementation environment shown in FIG. 1, and may be performed by the terminal device 110 in the implementation environment shown in FIG. 1, or may be performed by the server 120 in the implementation environment shown in FIG. 1, or may be performed by both the terminal device 110 and the server 120 in the implementation environment shown in FIG. 1.

As shown in FIG. 10, the data transmission method includes operation S210 to operation S240 and operation S1010 to operation S1020. Detailed descriptions of operation S1010 to operation S1020 are as follows.

Operation S1010: Select another communication network than a target communication network from a plurality of communication networks.

The another communication network is a communication network other than the target communication network in the plurality of communication networks.

Operation S1020: Transmit service data corresponding to the another communication service than the target communication services in the plurality of communication services through the another communication network.

To ensure data transmission of the other communication service than the target communication services in the plurality of communication services, service data corresponding to the other communication service may be transmitted through the another communication network.

It may be first determined whether a communication network with a smallest cost value corresponding to the other communication service exists in the another communication network. If yes, the service data corresponding to the other communication service is transmitted through the communication network with the smallest cost value corresponding to the other communication service. If not, a communication network is selected from the another communication network for transmitting service data corresponding to the other communication service.

For specific implementation details of operation S210 to operation S240 shown in FIG. 10, reference may be made to operation S210 to operation S240 shown in FIG. 2. Details are not described herein again.

In the embodiment shown in FIG. 10, the another communication network than the target communication network is selected from the plurality of communication networks, and service data corresponding to the other communication service than the target communication services in the plurality of communication services is transmitted through the another communication network, thereby ensuring normal transmission of the other communication service. In addition, services are provided to the communication terminal through the target communication network and the another communication network, so that communication performance of the communication terminal can be improved.

In an embodiment, FIG. 11 is a flowchart of a data transmission method according to another embodiment of this disclosure. The method may be applied to the implementation environment shown in FIG. 1, and may be performed by the terminal device 110 in the implementation environment shown in FIG. 1, or may be performed by the server 120 in the implementation environment shown in FIG. 1, or may be performed by both the terminal device 110 and the server 120 in the implementation environment shown in FIG. 1.

As shown in FIG. 11, the data transmission method includes operation S1110 to operation S1120 and operation S210 to operation S240. Detailed descriptions of operation S1110 to operation S1120 are as follows.

Operation S1110: Obtain a communication status parameter of a specified communication network of the plurality of communication networks, and determine communication quality of the specified communication network based on the communication status parameter of the specified communication network.

The specified communication network may be a preset communication network. For example, when the data transmission method is applied to the in-vehicle terminal, the specified communication network may be the vehicle direct communication network or the cellular communication network.

To ensure data transmission quality of the target communication service, the communication status parameter of the specified communication network may be obtained, and the communication quality of the specified communication network is determined based on the communication status parameter of the specified communication network.

Operation S1120: Use the specified communication network as the target communication network if the communication quality of the specified communication network is better than communication quality corresponding to a set communication status parameter.

A numerical value of the communication status parameter may represent the communication quality. If the communication quality of the specified communication network is better than the communication quality corresponding to the set communication status parameter, the specified communication network is used as the target communication network.

Correspondingly, different types of the set communication status parameters correspond to different manners of determining whether the communication quality of the specified communication network is better than the communication quality corresponding to the set communication status parameter. For example, if the set status parameter is the signal-to-noise ratio, on a condition that the signal-to-noise ratio of the specified communication network is greater than the set status parameter, it is determined that the communication quality of the specified communication network is better than the communication quality corresponding to the set communication status parameter. If the set status parameter is the network loading, it is determined that, on a condition that the network loading of the specified communication network is less than the set status parameter, the communication quality of the specified communication network is better than the communication quality corresponding to the set communication status parameter.

For specific implementation details of operation S210 to operation S240 shown in FIG. 11, reference may be made to operation S210 to operation S240 shown in FIG. 2. Details are not described herein again.

In the embodiment shown in FIG. 11, a communication status parameter of a specified communication network of the plurality of communication networks is obtained, and communication quality of the specified communication network is determined based on the communication status parameter of the specified communication network. If the communication quality of the specified communication network is better than the communication quality corresponding to the set communication status parameter, the specified communication network is used as the target communication network, to ensure the communication quality of the target communication network.

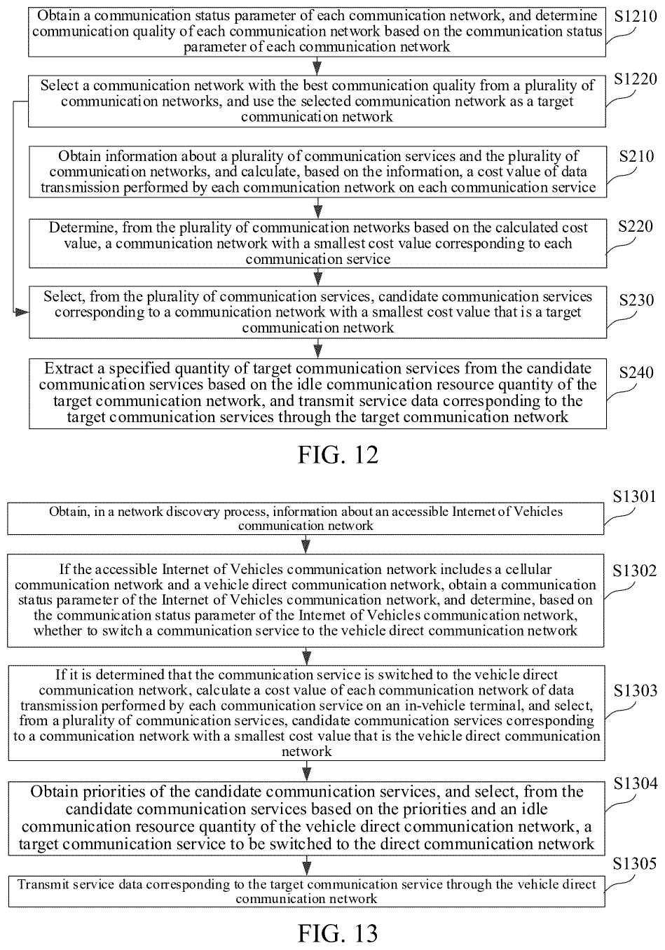

In an embodiment, FIG. 12 is a flowchart of a data transmission method according to another embodiment of this disclosure. The method may be applied to the implementation environment shown in FIG. 1, and may be performed by the terminal device 110 in the implementation environment shown in FIG. 1, or may be performed by the server 120 in the implementation environment shown in FIG. 1, or may be performed by both the terminal device 110 and the server 120 in the implementation environment shown in FIG. 1.

As shown in FIG. 12, the data transmission method includes operation S1210 to operation S1220 and operation S210 to operation S240. Detailed descriptions of operation S1210 to operation S1220 are as follows.

Operation S1210: Obtain a communication status parameter of each communication network, and determine communication quality of each communication network based on the communication status parameter of each communication network.

To determine the target communication network, the communication status parameter of each communication network in the plurality of communication networks may be obtained, and the communication quality of each communication network is determined based on the communication status parameter of each communication network.

Operation S1220: Select a communication network with the best communication quality from the plurality of communication networks, and use a selected communication network as the target communication network.

The communication network with the best communication quality in the plurality of communication networks is used as the target communication network, so that the communication quality of the target communication service can be ensured.

For specific implementation details of operation S210 to operation S240 shown in FIG. 12, reference may be made to operation S210 to operation S240 shown in FIG. 2. Details are not described herein again.

In the embodiment shown in FIG. 12, the communication status parameter of each communication network is obtained, and the communication quality of each communication network is determined based on the communication status parameter of each communication network. The communication network with the best communication quality is selected from the plurality of communication networks, and the selected communication network is used as the target communication network, to ensure the communication quality of the target communication network.

In an embodiment, an example in which the data transmission method is applied to the in-vehicle terminal, and the communication network includes the vehicle direct communication network and the cellular communication network is used for description. As shown in FIG. 13, the data transmission method includes operation S1301 to operation S1305, which are described in detail as follows.

Operation S1301: Obtain, in a network discovery process, information about an accessible Internet of Vehicles communication network.

The in-vehicle terminal may obtain information about a currently accessible Internet of Vehicles communication network in the network discovery process. The in-vehicle terminal determines whether the in-vehicle terminal can access the vehicle direct communication network and the cellular communication network.

Operation S1302: Obtain, if the accessible Internet of Vehicles communication network includes a cellular communication network and a vehicle direct communication network, a communication status parameter of the Internet of Vehicles communication network, and determine, based on the communication status parameter of the Internet of Vehicles communication network, whether to switch a communication service to the vehicle direct communication network.

If the accessible Internet of Vehicles communication network includes the vehicle direct communication network and the cellular communication network, a selection may be performed between the vehicle direct communication network and the cellular communication network. Therefore, the in-vehicle terminal may obtain the communication status parameter of the Internet of Vehicles communication network, and determine, based on the communication status parameter of the Internet of Vehicles communication network, whether to switch the communication service to the vehicle direct communication network.

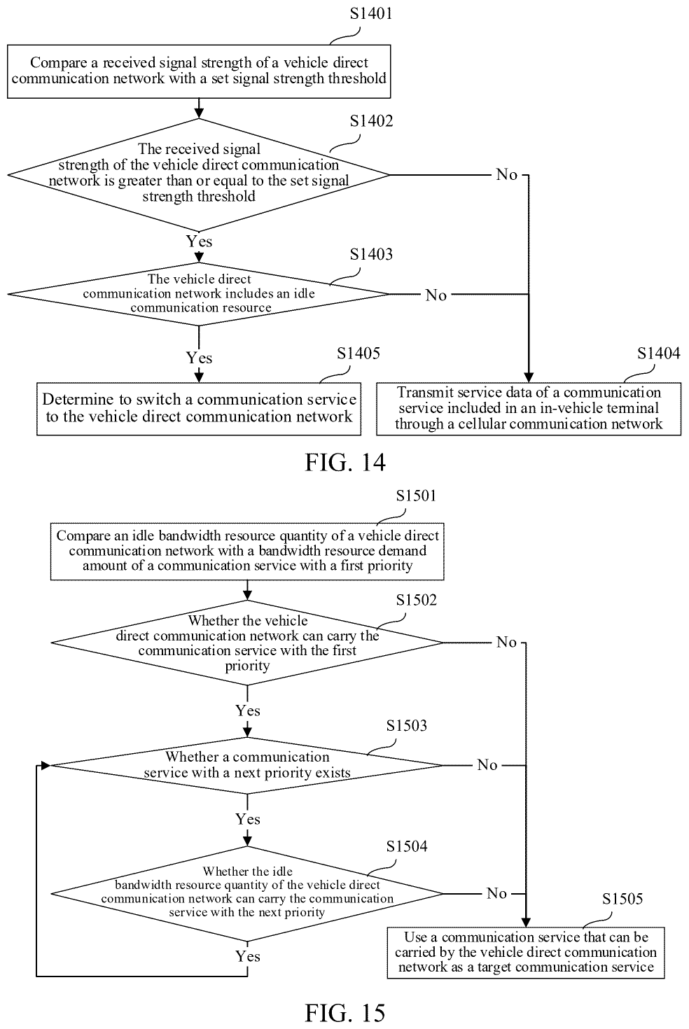

As shown in FIG. 14, a process of determining, based on the communication status parameter of the Internet of Vehicles communication network, whether to switch the communication service to the vehicle direct communication network (the foregoing operation S1302) may include operation S1401 to operation S1405, which are described in detail as follows.

Operation S1401: Compare a received signal strength of a vehicle direct communication network with a set signal strength threshold.

For example, if the communication status parameter of the vehicle direct communication network includes the received signal strength, the received signal strength of the vehicle direct communication network may be compared with the set signal strength threshold.

Operation S1402: Determine whether a received signal strength of the vehicle direct communication network is greater than or equal to the set signal strength threshold. If yes, skip to operation S1403. If not, skip to operation S1404.

Operation S1403: Determine whether the vehicle direct communication network includes an idle communication resource. If yes, skip to operation S1405. If not, skip to operation S1404.

For example, if the communication status parameter of the vehicle direct communication network includes the idle communication resource quantity, whether the vehicle direct communication network includes the idle communication resource may be determined based on the idle communication resource quantity.

An idle communication resource quantity threshold may further be set, and it is determined whether a quantity of trusted communication resources included in the vehicle direct communication network is greater than the idle communication resource quantity threshold. If yes, skip to operation S1405.

Operation S1404: Transmit service data of a communication service included in an in-vehicle terminal through a cellular communication network.

If the received signal strength of the vehicle direct communication network is less than the set signal strength threshold, or the vehicle direct communication network does not include the idle communication resource, the communication service is not switched to the vehicle direct communication network, and the service data of the communication service included in the in-vehicle terminal is directly transmitted through the cellular communication network.

Operation S1405: Determine to switch the communication service to the vehicle direct communication network.

If the received signal strength of the vehicle direct communication network is greater than or equal to the set signal strength threshold, and the vehicle direct communication network includes the idle communication resource, it is determined that the communication service is switched to the vehicle direct communication network. Skip to operation S1303 to start a switching procedure.

Operation S1303: Calculate, if it is determined that the communication service is switched to the vehicle direct communication network, a cost value of each communication network of data transmission performed by each communication service on the in-vehicle terminal, and select a communication network with a smallest cost value from a plurality of communication services as a candidate communication service of the vehicle direct communication network.

If it is determined that the communication service is switched to the vehicle direct communication network, the switching procedure is started. First, the cost value of data transmission performed by each communication network on each communication service of the in-vehicle terminal is calculated, and the communication network with the smallest cost value corresponding to each communication service is determined.

The cost value of data transmission performed by each communication network on each communication service may be calculated by using C_{n,a}=Σw_{a,i} u_{n,a,i} (Formula 1). In an example, it is assumed that the communication service is a blind spot vehicle reminder service, and a service requirement parameter of the blind spot vehicle reminder service includes: a transmission delay is less than or equal to 50 ms, a transmission reliability is greater than or equal to 99.9%, and a bandwidth is greater than or equal to 1 kbps. Referring to Table 1 and Table 2 below. A cost value corresponding to the service requirement parameter of the blind spot vehicle reminder service is shown in the following Table 1, and a weight value corresponding to the service requirement parameter of the blind spot vehicle reminder service is shown in the following Table 2.

TABLE 1

| | | Cost value | Cost value |
|---|---|---|---|
| | Cost value | corresponding | corresponding |
| | corresponding | to transmission | to transmission |
| | to bandwidth | delay | reliability |
| | u_{n, a, i} = 1 | u_{n, a, i} = 2 | u_{n, a, i} = 3 |
| Cellular | 1 | 5 | 3 |
| communication | | | |
| network n = 1 | | | |
| Vehicle direct | 1 | 1 | 4 |
| communication | | | |
| network n = 2 | | | |

TABLE 2

| | Bandwidth | Delay | Reliability |
|---|---|---|---|
| Weight value of blind spot | 0.1 | 0.4 | 0.5 |
| vehicle reminder service | | | |

In this case, for the blind spot vehicle reminder service, the cost value corresponding to the blind spot vehicle reminder service is calculated as follows:

A cost value corresponding to the cellular communication network is C_{n=1,a}=0.1×1+0.4×5+0.5×3=3.6; and

a cost value corresponding to the vehicle direct communication network is C_{n=2,a}=0.1×1+0.4×1+0.5×4=2.5.

Therefore, for the blind spot vehicle reminder service, the communication network with the smallest cost value corresponding to the blind spot vehicle reminder service is:

$${n}_{a - opt} = arg min ( {C}_{n = 1 , a} , {C}_{n = 2 , a} ) = 2$$

nₐ₋ₒₚₜ is a serial number corresponding to the communication network with the smallest cost value. For the blind spot vehicle reminder service, the communication network with the smallest cost value corresponding to the blind spot vehicle reminder service is a communication network with a serial number 2, that is, the vehicle direct communication network.

Operation S1304: Obtain priorities of candidate communication services, and select, from the candidate communication services based on the priorities and an idle communication resource quantity of the vehicle direct communication network, a target communication service to be switched to the direct communication network.

The priority of the communication service may be determined based on the service requirement parameter of the communication service and the communication service type. For example, the priority is calculated based on Pₐ=Dₐ·Tₐ and the service requirement parameter table and the service type parameter table. In an example, an example in which the service requirement parameter is the transmission delay is used for description. Referring to Table 3 and Table 4 below. Table 3 is a service requirement parameter table, and Table 4 is a service type parameter table. It is assumed that a communication service is a driving security type service, and the transmission delay requirement parameter of the communication service is less than or equal to 50 milliseconds, the priority corresponding to the communication service is: 5*4=20

TABLE 3

| Transmission delay requirement | Priority value Dₐ |
|---|---|
| ≤20 ms | 5 |
| ≤50 ms | 4 |
| ≤100 ms | 2 |
| ≤200 ms | 1 |

TABLE 4

| | Priority value corresponding |
|---|---|
| Communication service type | to service type Tₐ |
| Driving security | 5 |
| Driving efficiency | 2 |
| Information service | 1 |

Referring to FIG. 15, a process of selecting a to-be-switched communication service to the direct communication network based on the priority and the idle communication resource quantity of the direct communication network (the foregoing operation S1304) may include operation S1501 to operation S1505. A detailed description is as follows.

Operation S1501: Compare an idle bandwidth resource quantity of a vehicle direct communication network with a bandwidth resource demand amount of a communication service with a first priority.

An example in which the communication resource is a bandwidth resource is used for description. The first priority is the highest priority.

Operation S1502: Determine whether the vehicle direct communication network can carry the communication service with the first priority. If not, skip to operation S1505. If yes, skip to operation S1503.

If the idle bandwidth resource quantity of the vehicle direct communication network is greater than the bandwidth resource demand amount of the communication service with the highest priority, it is determined that the vehicle direct communication network can carry the communication service with the highest priority.

Operation S1503: Determine whether a communication service with a next priority exists. If yes, skip to operation S1504. If not, skip to operation S1505.

For the first priority, the next priority is a second priority, for the second priority, the next priority is a third priority, and so on.

Operation S1504: Determine whether the idle bandwidth resource quantity of the vehicle direct communication network can carry the communication service with the next priority. If yes, skip to operation S1503. If not, skip to operation S1505.

The bandwidth resource demand amount of the extracted communication service may be subtracted from the idle bandwidth resource quantity of the vehicle direct communication network to obtain the remaining bandwidth resource quantity, and it is determined whether the remaining bandwidth resource quantity is greater than the bandwidth resource demand amount corresponding to the communication service with the next priority. If yes, it is determined that the idle bandwidth resource quantity of the vehicle direct communication network can carry the communication service with the next priority. If not, it is determined that the idle bandwidth resource quantity of the vehicle direct communication network cannot carry the communication service with the next priority. The extracted communication service is a communication service that is determined to be capable of being carried by the vehicle direct communication network. That is, a communication service with a priority higher than the next priority.

S1505: Use a communication service that can be carried by the vehicle direct communication network as a target communication service.

S1305: Transmit service data corresponding to the target communication service through the vehicle direct communication network.

After the target communication service is determined, the service data corresponding to the target communication service is transmitted through the vehicle direct communication network. That is, the target communication service is switched to the vehicle direct communication network to perform data transmission.

In the embodiment shown in FIG. 13, the communication service with the higher priority can be switched to the vehicle direct communication network. In this way, the probability of overloading and crashing the vehicle direct communication network can be reduced, and the data transmission performance of the communication service with the higher priority can be ensured.

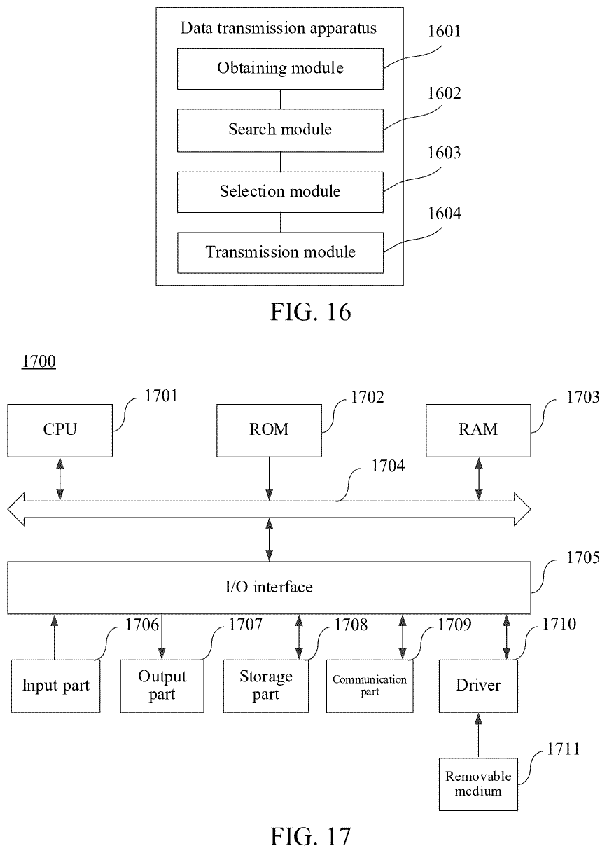

FIG. 16 is a block diagram of a data transmission apparatus according to an embodiment of this disclosure. As shown in FIG. 16, the apparatus includes the following modules:
an obtaining module 1601 is configured to obtain information about a plurality of communication services and a plurality of communication networks, and calculate, based on the information, a cost value of data transmission performed by each communication network in the plurality of communication networks on each communication service in the plurality of communication services;
a search module 1602 is configured to determine, from the plurality of communication networks based on a calculated cost value, a communication network with a smallest cost value corresponding to each communication service;
a selection module 1603 is configured to select, from the plurality of communication services, candidate communication services corresponding to a communication network with a smallest cost value that is a target communication network; and
a transmission module 1604 is configured to extract a specified quantity of target communication services from the candidate communication services based on an idle communication resource quantity of the target communication network, and transmit service data corresponding to the target communication services through the target communication network.

In an embodiment of this disclosure, based on the foregoing solutions, the obtaining module 1601 is further configured to: obtain a service requirement parameter of each communication service; and calculate, based on the service requirement parameter of each communication service, a cost value of data transmission performed by each communication network on each communication service.

In an embodiment of this disclosure, based on the foregoing solutions, the obtaining module 1601 may be, in some examples, configured to: obtain a service requirement parameter of each communication service and feature information of each communication network; and calculate, based on the service requirement parameter of each communication service and the feature information of each communication network, a cost value of data transmission performed by each communication network on each communication service.

In an embodiment of this disclosure, based on the foregoing solutions, the obtaining feature information of each communication network includes: obtaining at least one of attribute feature information and a communication status parameter of each communication network.

In an embodiment of this disclosure, based on the foregoing solutions, the service requirement parameter of each communication service includes a plurality of service requirement parameters of each communication service. The calculating, based on the service requirement parameter of each communication service, a cost value of data transmission performed by each communication network on each communication service includes: calculating a cost value corresponding to each service requirement parameter of each communication service based on a matching degree between each service requirement parameter of each communication service and each communication network; and perform weighted summation on cost values corresponding to the plurality of service requirement parameters of each communication service, to obtain the cost value of data transmission performed by each communication network on each communication service. When weighted summation is performed on the cost values corresponding to the plurality of service requirement parameters of each communication service, weight values respectively corresponding to the plurality of service requirement parameters of each communication service may be first obtained.

In an embodiment of this disclosure, based on the foregoing solutions, the transmission module 1604 is further configured to: obtain an idle communication resource quantity of the target communication network and a communication resource demand amount of each candidate communication service; sequentially extract communication services from the candidate communication services in descending order of corresponding priorities until a total resource demand amount corresponding to extracted communication services matches the idle communication resource quantity; and use the extracted communication service as the target communication service.

In an embodiment of this disclosure, based on the foregoing solutions, the apparatus further includes: an obtaining unit, configured to obtain a service requirement parameter and a service type of each communication service; and a determining unit, configured to determine a priority of each communication service based on the service requirement parameter and the service type of each communication service.

In an embodiment of this disclosure, based on the foregoing solutions, the determining a priority of each communication service based on the service requirement parameter and the service type of each communication service includes: searching for a priority value corresponding to a service requirement parameter value of each communication service from a set service requirement parameter table, the service requirement parameter table comprising priority values corresponding to different value ranges of the service requirement parameter; searching for a priority value corresponding to the service type of each communication service from a set service type parameter table, the service type parameter table including priority values corresponding to different service types; and determining the priority of each communication service based on the priority value corresponding to the service requirement parameter value of each communication service and the priority value corresponding to the service type of each communication service.

In an embodiment of this disclosure, based on the foregoing solutions, the apparatus further includes: a selection module, configured to select another communication network than a target communication network from a plurality of communication networks; and a communication module, configured to transmit service data corresponding to the other communication service than the target communication services in the plurality of communication services through the another communication network.

In an embodiment of this disclosure, based on the foregoing solutions, the apparatus further includes: a target determining module, configured to: obtain a communication status parameter of a specified communication network of a plurality of communication networks, and determine communication quality of the specified communication network based on the communication status parameter of the specified communication network; and use, if the communication quality of the specified communication network is better than the communication quality corresponding to the set communication status parameter, the specified communication network as the target communication network.

In an embodiment of this disclosure, based on the foregoing solution, the apparatus is applied to an in-vehicle terminal, and the specified communication network includes a vehicle direct communication network or a cellular communication network.

In an embodiment of this disclosure, based on the foregoing solutions, the apparatus further includes: a target determining unit, configured to: obtain a communication status parameter of each communication network determine communication quality of each communication network based on the communication status parameter of each communication network; and select a communication network with the best communication quality from a plurality of communication networks, and use a selected communication network as a target communication network.

The apparatus provided in the foregoing embodiment and the method provided in the foregoing embodiment are based on the same concept. The specific manners of performing operations by each module and unit of the apparatus have been described in detail in the method embodiment.

An embodiment of this disclosure further provides an electronic device, including: one or more processors (also referred to as processing circuitry); and a memory (also referred to as non-transitory computer-readable storage medium), configured to store one or more computer programs, the one or more computer programs, when executed by one or more processors, causing the electronic device to implement the data transmission method as described above.

FIG. 17 is a schematic structural diagram of a computer system adapted to implement an electronic device according to an embodiment of this disclosure.

The computer system 1700 of the electronic device shown in FIG. 17 is merely an example, and does not constitute any limitation on functions and use ranges of the embodiments of this disclosure.

As shown in FIG. 17, the computer system 1700 includes a central processing unit (CPU) 1701, which may perform various suitable actions and processing based on a program stored in a read-only memory (ROM) 1702 or a program loaded from a storage part 1708 into a random access memory (RAM) 1703, for example, perform the method described in the foregoing embodiments. The RAM 1703 further has various programs and data required for operating the system stored therein. The CPU 1701, the ROM 1702, and the RAM 1703 are connected to each other through a bus 1704. An input/output (I/O) interface 1705 is also connected to the bus 1704.

The following components are connected to the I/O interface 1705: an input part 1706 including a keyboard, a mouse, or the like; an output part 1707 including a cathode ray tube (CRT), a liquid crystal display (LCD), a speaker, or the like; a storage part 1708 including hard disk, or the like; and a communication part 1709 including a network interface card such as a local area network (LAN) card, a modem, or the like. The communication part 1709 performs communication processing by using a network such as the Internet. A driver 1710 is also connected to the I/O interface 1705 as required. A removable medium 1711, such as a magnetic disk, an optical disc, a magneto-optical disk, or a semiconductor memory, is installed on the driver 1710 as required, so that a computer program read from the removable medium is installed into the storage part 1708 as required.

Particularly, according to an embodiment of this disclosure, the processes described above with reference to the flowcharts may be implemented as computer software programs. For example, an embodiment of this disclosure includes a computer program product. The computer program product includes a computer program stored in a computer-readable medium. The computer program includes a computer program configured for performing the method shown in the flowchart. In such an embodiment, the computer program may be downloaded and installed from a network through the communication part 1709, and/or installed from the removable medium 1711. When the computer program is executed by the CPU 1701, the various functions defined in the system of this disclosure are executed.

The computer-readable medium shown in the embodiments of this disclosure may be a computer-readable signal medium or a computer-readable storage medium or any combination of two. The computer-readable medium may be, for example, an electrical, magnetic, optical, electromagnetic, infrared, or semiconductor system, apparatus, or device, or any combination thereof. More specific examples of the computer readable medium may include, but are not limited to: an electrical connection having one or more wires, a portable computer magnetic disk, a hard disk, a random access memory (RAM), a read-only memory (ROM), an erasable programmable read-only memory (EPROM), a flash memory, an optical fiber, a compact disk read-only memory (CD-ROM), an optical storage device, a magnetic storage device, or any appropriate combination thereof. In this disclosure, the computer-readable medium may be any tangible medium including or storing a program, and the program may be used by or used in combination with an instruction execution system, an apparatus, or a device. In this disclosure, a computer-readable signal medium may include a data signal in a baseband or propagated as a part of a carrier wave, the data signal carrying a computer-readable computer program. A data signal propagated in such a way may be in a plurality of forms, including, but not limited to, an electromagnetic signal, an optical signal, or any appropriate combination thereof. The computer-readable signal medium may be further any computer-readable medium in addition to a computer-readable storage medium. The computer-readable medium may send, propagate, or transmit a program that is used by or used in combination with an instruction execution system, an apparatus, or a device. The computer program included in the computer-readable storage medium may be transmitted using any suitable medium, including but not limited to: a wireless medium, a wire medium, or the like, or any suitable combination thereof.

The flowcharts and block diagrams in the accompanying drawings illustrate possible system architectures, functions, and operations that may be implemented by a system, a method, and a computer program product according to various embodiments of this disclosure. Each box in a flowchart or a block diagram may represent a module, a program segment, or a part of code. The module, the program segment, or the part of code includes one or more executable instructions configured for implementing designated logic functions. In some implementations used as substitutes, functions marked in boxes may alternatively occur in a sequence different from that marked in an accompanying drawing. For example, two boxes shown in succession may actually be performed basically in parallel, and sometimes the two boxes may be performed in a reverse sequence. This is determined by a related function. Each box in the block diagram or the flowchart, and a combination of blocks in the block diagram or the flowchart may be implemented by using a dedicated hardware-based system that performs a specified function or operation, or may be implemented by using a combination of dedicated hardware and computer instructions.

Related units described in the embodiments of this disclosure may be implemented in a software manner, or may be implemented in a hardware manner, and the unit described can also be set in a processor. Names of the units do not constitute a limitation on the units in a specific case.

Another aspect of this disclosure further provides a computer-readable medium, having a computer program stored therein. The computer program, when executed by a processor, implements the data transmission method as described above. The computer-readable medium may be included in the electronic device described in the foregoing embodiments, or may exist alone and is not disposed in the electronic device.

Another aspect of this disclosure further provides a computer program product or a computer program, including computer instructions, the computer instructions being stored in a computer-readable medium. A processor of a computer device reads the computer instructions from the computer-readable medium, and the processor executes the computer instructions to cause the computer device to perform the data transmission method provided in the foregoing various embodiments.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive

What is claimed is:

1. A method of data transmission, comprising:
obtaining communication service information and communication network information associated with a communication terminal device, the communication service information indicating a plurality of communication services to be performed for the communication terminal device, and the communication network information indicating a plurality of communication networks that are available to the communication terminal device;
calculating, based on the communication service information and the communication network information, respective cost values of data transmission by the plurality of communication networks on each communication service of the plurality of communication services;
determining, from the plurality of communication networks and based on the respective cost values, a potential target communication network with a smallest cost value for each communication service in the plurality of communication services;
selecting, from a set of communication services having a first communication network as the potential target communication network, first one or more candidate communication services with one or more smallest cost values, the first communication network being a target communication network;
determining one or more target communication services from the first one or more candidate communication services based on an idle communication resource quantity of the first communication network; and
transmitting service data of the one or more target communication services through the first communication network.

2. The method according to claim 1, wherein:
the obtaining comprises:
obtaining respective service requirement parameters of the plurality of communication services; and
the calculating comprises:
calculating, based on the respective service requirement parameters of the plurality of communication services, the respective cost values of the data transmission by the plurality of communication networks on each communication service of the plurality of communication services.

3. The method according to claim 1, wherein:
the obtaining comprises:
obtaining respective service requirement parameters of the plurality of communication services, and
obtaining respective feature information of the plurality of communication networks; and
the calculating comprises:
calculating, based on the respective service requirement parameters of the plurality of communication services and the respective feature information of the plurality of communication networks, the respective cost values of the data transmission by the plurality of communication networks on each communication service of the plurality of communication services.

4. The method according to claim 3, wherein the obtaining the respective feature information of the plurality of communication networks comprises:
obtaining at least one of attribute feature information or a communication status parameter of each communication network in the plurality of communication networks.

5. The method according to claim 2, wherein:
a first communication service comprises:
a plurality of service requirement parameters; and
the calculating comprises:
calculating, for a communication network in the plurality of communication networks, respective component cost values associated with the plurality of service requirement parameters of the first communication service based on a matching degree of the plurality of service requirement parameters of the first communication service and the communication network; and
performing a weighted summation on the respective component cost values associated with the plurality of service requirement parameters, to obtain a cost value of the data transmission of the communication network performing the first communication service.

6. The method according to claim 1, wherein the determining the one or more target communication services comprises:
determining the idle communication resource quantity of the first communication network and respective communication resource demand amounts of the first one or more candidate communication services; and
sequentially selecting the one or more target communication services from the first one or more candidate communication services in descending order of priorities until a total resource demand amount of the one or more target communication services matches the idle communication resource quantity.

7. The method according to claim 6, further comprising:
obtaining a service requirement parameter and a service type of a first candidate communication service in the first one or more candidate communication services; and
determining a priority of the first candidate communication service based on the service requirement parameter and the service type of the first candidate communication service.

8. The method according to claim 7, wherein the determining the priority comprises:
determining a first priority value corresponding to a service requirement parameter value of the first candidate communication service from a set service requirement parameter table, the set service requirement parameter table comprising first priority values corresponding to different value ranges of the service requirement parameter;
determining a second priority value corresponding to the service type of the first candidate communication service from a set service type parameter table, the set service type parameter table comprising second priority values corresponding to different service types; and
determining the priority of the first candidate communication service based on the first priority value and the second priority value.

9. The method according to claim 1, further comprising:
selecting a second communication network other than the first communication network from the plurality of communication networks; and
transmitting service data of another communication service in the plurality of communication services other than the one or more target communication services through the second communication network.

10. The method according to claim 1, further comprising:
obtaining a communication status parameter of a specified communication network in the plurality of communication networks;
determining a communication quality of the specified communication network based on the communication status parameter of the specified communication network; and
using the specified communication network as the target communication network when the communication quality of the specified communication network is better than a predefined communication quality corresponding to a pre-set communication status parameter.

11. The method according to claim 1, further comprising:
obtaining respective communication status parameters of the plurality of communication networks;
determining respective communication qualities of the plurality of communication networks based on the respective communication status parameters; and
selecting the first communication network with a best communication quality from the plurality of communication networks as the target communication network.

12. An apparatus for data transmission, comprising processing circuitry configured to:
obtain communication service information and communication network information of a communication terminal device, the communication service information indicating a plurality of communication services to be performed for the communication terminal device, and the communication network information indicating a plurality of communication networks that are available to the communication terminal device;
calculate, based on the communication service information and the communication network information, respective cost values of data transmission by the plurality of communication networks on each communication service of the plurality of communication services;
determine, from the plurality of communication networks and based on the respective cost values, a potential target communication network with a smallest cost value for each communication service in the plurality of communication services;
select, from a set of communication services having a first communication network as the potential target communication network, first one or more candidate communication services with one or more smallest cost values, the first communication network being a target communication network;
determine one or more target communication services from the first one or more candidate communication services based on an idle communication resource quantity of the first communication network; and
transmit service data of the one or more target communication services through the first communication network.

13. The apparatus according to claim 12, wherein the processing circuitry is configured to:
obtain respective service requirement parameters of the plurality of communication services; and
calculate, based on the respective service requirement parameters of the plurality of communication services, the respective cost values of the data transmission by the plurality of communication networks on each communication service of the plurality of communication services.

14. The apparatus according to claim 12, wherein the processing circuitry is configured to:
obtain respective service requirement parameters of the plurality of communication services;
obtain respective feature information of the plurality of communication networks; and
calculate, based on the respective service requirement parameters of the plurality of communication services and the respective feature information of the plurality of communication networks, the respective cost values of the data transmission by the plurality of communication networks on each communication service of the plurality of communication services.

15. The apparatus according to claim 14, wherein the processing circuitry is configured to:
obtain at least one of attribute feature information and/or a communication status parameter of each communication network in the plurality of communication networks.

16. The apparatus according to claim 13, wherein a first communication service comprises a plurality of service requirement parameters, and the processing circuitry is configured to:
calculate, for a communication network in the plurality of communication networks, respective component cost values associated with the plurality of service requirement parameters of the first communication service based on a matching degree of the plurality of service requirement parameters of the first communication service and the communication network; and
perform weighted summation on the respective cost values associated with the plurality of service requirement parameters, to obtain a cost value of the data transmission of the communication network performing the first communication service.

17. The apparatus according to claim 12, wherein the processing circuitry is configured to:
determine the idle communication resource quantity of the first communication network and respective communication resource demand amounts of the first one or more candidate communication services; and
sequentially select the one or more target communication services from the first one or more candidate communication services in a descending order of priorities until a total resource demand amount of the one or more target communication services matches the idle communication resource quantity.

18. The apparatus according to claim 17, wherein the processing circuitry is configured to:
obtain a service requirement parameter and a service type of a first candidate communication service in the first one or more candidate communication services; and
determine a priority of the first candidate communication service based on the service requirement parameter and the service type of the first candidate communication service.

19. The apparatus according to claim 18, wherein the processing circuitry is configured to:
determine a first priority value corresponding to a service requirement parameter value of the first candidate communication service from a set service requirement parameter table, the set service requirement parameter table comprising first priority values corresponding to different value ranges of the service requirement parameter;
determine a second priority value corresponding to the service type of the first candidate communication service from a set service type parameter table, the set service type parameter table comprising second priority values corresponding to different service types; and
determine the priority of the first candidate communication service based on the first priority value and the second priority value.

20. A non-transitory computer-readable storage medium storing instructions which when executed by at least one processor cause the at least one processor to perform:
obtaining communication service information and communication network information associated with a communication terminal device, the communication service information indicating a plurality of communication services to be performed for the communication terminal device, and the communication network information indicating a plurality of communication networks that are available to the communication terminal device;
calculating, based on the communication service information and the communication network information, respective cost values of data transmission by the plurality of communication networks on each communication service of the plurality of communication services;
determining, from the plurality of communication networks and based on the respective cost values, a potential target communication network with a smallest cost value for each communication service in the plurality of communication services;
selecting, from a set of communication services having a first communication network as the potential target communication network, first one or more candidate communication services with one or more smallest cost values, the first communication network being a target communication network;
determining one or more target communication services from the first one or more candidate communication services based on an idle communication resource quantity of the first communication network; and
transmitting service data of the one or more target communication services through the first communication network.
